(19) United States
(12) Patent Application Publication
(10) Pub. No.: US 2018/0262662 A1
(43) Pub. Date: Sep. 13, 2018

(54) IMAGE CAPTURING DEVICE AND METHOD FOR MANUFACTURING IMAGE CAPTURING DEVICE

(71) Applicant: FUJITSU FRONTECH LIMITED, Inagi (JP)

(72) Inventors: Isao IWAGUCHI, Inagi (JP); Kozo Yamazaki, Inagi (JP)

(73) Assignee: FUJITSU FRONTECH LIMITED, Inagi (JP)

(21) Appl. No.: 15/976,247

(22) Filed: May 10, 2018

Related U.S. Application Data
(63) Continuation of application No. PCT/JP2015/083632, filed on Nov. 30, 2015.

(51) Int. Cl. H04N 5/225; F21V 8/00

(52) U.S. Cl. CPC H04N 5/2254; G02B 6/0013; H04N 5/2253

(57) ABSTRACT

An image capturing device includes an imaging device, a board on which the imaging device is mounted, an optical unit that forms an image of a target object onto the imaging device, and mounting units that is used to mount the optical unit on the board. The mounting units include a first mounting unit and a second mounting unit and the board includes an attachment portion having a smooth surface. The first mounting unit is attached to the attachment portion by mechanical joining and the second mounting unit is bonded to the first mounting unit while the optical unit is attached to the second mounting unit.

### CROSS-REFERENCE TO RELATED APPLICATION

This application is a continuation application of International Application PCT/JP2015/083632, filed on Nov. 30, 2015, the entire contents of which are incorporated herein by reference.

### FIELD

The embodiments discussed herein are directed to an image capturing device and a method for manufacturing the image capturing device.

### BACKGROUND

In recent years, biometric authentication has been widely used. Biometric authentication is used for authentication determining whether an operator of a computer or the like is a valid operator, for example, used for authentication of an operator of a POS (Point Of Sales) cash register in a store. In such a case, an image capturing device captures an image of, for example, person's palm veins. If the feature of veins based on the image captured by the image capturing device matches the feature of previously registered veins, the person is authenticated. The POS cash register receives only the operation performed by the operator verified by biometric authentication.

In the image capturing device used for various purposes including biometric authentication, in a manufacturing process, for example, an image sensor and a lens unit including lenses arranged to introduce external light to the image sensor are aligned by sliding the lens unit on an arrangement member in which the image sensor is installed. Then, in the image capturing device, the lens unit and the arrangement member are bonded by using an adhesive in the state in which the lens unit and the image sensor are aligned (for example, see Patent Literature 1).
Patent Literature 1: Japanese Laid-open Patent Publication No. 2006-128931

In response to a recent request for ease of portability, downsizing of the image capturing device is enhanced. Such a portable image capturing device tends to be carelessly dropped and receives an impact. However, with the conventional technology described above, due to constraints resulting from the downsizing, an adhesive area is decreased, for example, the lens unit and the arrangement member of the image capturing device are bonded by point adhesion, and thus, the adhesive strength is not firmly secured. Furthermore, if surfaces which the lens unit and the arrangement member are slid on each other are formed smoothly, alignment based on the sliding is easy; however, the adhesive strength is further decreased due to adhesion performed on the smooth surface. Consequently, with the conventional technology described above, there is a problem in that, when the image capturing device receives impacts or vibrations, the adhesive section of the lens unit, the arrangement member, and the like peel off due to shear, i.e., the resistance against impacts or vibrations is low.

### SUMMARY

According to an aspect of an embodiment, an image capturing device includes, an imaging device, a board on which the imaging device is mounted, an optical unit that forms an image of a target object on the imaging device, and a mounting unit that is used to mount the optical unit on the board, wherein the mounting unit includes a first mounting unit and a second mounting unit, the board includes an attachment portion having a smooth surface, the first mounting unit is attached to the attachment portion by mechanical joining, and the second mounting unit to which the optical unit is attached is bonded to the first mounting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a sectional view illustrating an image capturing device according to a first embodiment.

FIG. 2 is an exploded perspective view illustrating the image capturing device according to the first embodiment.

FIG. 3 is a plan view illustrating a board included in the image capturing device according to the first embodiment.

FIG. 4 is a perspective view illustrating the main section of the image capturing device according to the first embodiment.

FIG. 5 is an exploded perspective view illustrating an outer packaging section of the image capturing device according to the first embodiment.

FIG. 6 is a perspective view illustrating the section except for a visible light cut filter plate of the image capturing device according to the first embodiment.

FIG. 7 is a perspective view illustrating the image capturing device according to the first embodiment.

FIG. 8 is a diagram illustrating an aspect in which a optical unit or the like of the image capturing device according to the first embodiment is attached to a camera board.

FIG. 9 is a diagram illustrating a mount attachment portion in which a lower-side mount of the image capturing device according to the first embodiment is attached to the camera board.

FIG. 10A is a perspective view illustrating the lower-side mount of the image capturing device according to the first embodiment.

FIG. 10B is a perspective view illustrating the state in which the lower-side mount of the image capturing device according to the first embodiment is attached to the mount attachment portion on the camera board.

FIG. 11 is a sectional view illustrating the state in which the optical unit or the like of the image capturing device according to the first embodiment is attached to the camera board.

FIG. 12A is a side view illustrating the aspect in which positional adjustment of the optical unit and the upper-side mount of the image capturing device according to the first embodiment is performed on the camera board in the direction of the X-axis and the Y-axis.

FIG. 12B is a plan view illustrating the aspect in which positional adjustment of the optical unit and the upper-side mount of the image capturing device according to the first embodiment is performed on the camera board in the direction of the X-axis and the Y-axis.

FIG. 13 is a diagram illustrating a target mark that is used when positional adjustment of the optical unit and the lower-side mount of the image capturing device according to the first embodiment is performed on the camera board in the direction of the X-axis and the Y-axis.

FIG. 14 is a diagram illustrating the aspect in which the focus adjustment of the upper-side mount of the optical unit of the image capturing device according to the first embodiment is performed in the Z-axis direction.

FIG. 15 is a diagram illustrating the aspect in which the upper-side mount of the optical unit of the image capturing device according to the first embodiment is bonded to the lower-side mount.

FIG. 16 is a flowchart illustrating an attachment process of attaching the optical unit of the image capturing device according to the first embodiment to the camera board.

FIG. 17A is a perspective view illustrating a lower-side mount of an image capturing device according to a second embodiment.

FIG. 17B is a perspective view illustrating the state in which the lower-side mount of the image capturing device according to the second embodiment is attached to a mount attachment portion on a camera board.

FIG. 18 is a sectional view illustrating an image capturing device according to a third embodiment.

FIG. 19 is a diagram illustrating the aspect in which a optical unit of the image capturing device according to the third embodiment is attached to a camera board.

### DESCRIPTION OF EMBODIMENTS

Preferred embodiments of an image capturing device and a method for manufacturing the image capturing device according to the present invention will be explained with reference to accompanying drawings. Furthermore, in each of the embodiments below, a description will be given by using, as an example, an image capturing device that is used for a vein authentication apparatus that performs authentication of persons based on the features of persons' veins; however, the embodiments do not limit the disclosed technology. Furthermore, in general, the disclosed technology can be used for the image capturing device having the configuration in which a predetermined optical unit is attached on a board on which an image sensor or the like is mounted. Furthermore, each of the embodiments can be used in any appropriate combination as long as the embodiments do not conflict with each other. Furthermore, in each of the embodiments, the same reference numerals are assigned to the same configurations and processes and descriptions of already described configurations and processes will be omitted.

### First Embodiment

(Image Capturing Device According to a First Embodiment)

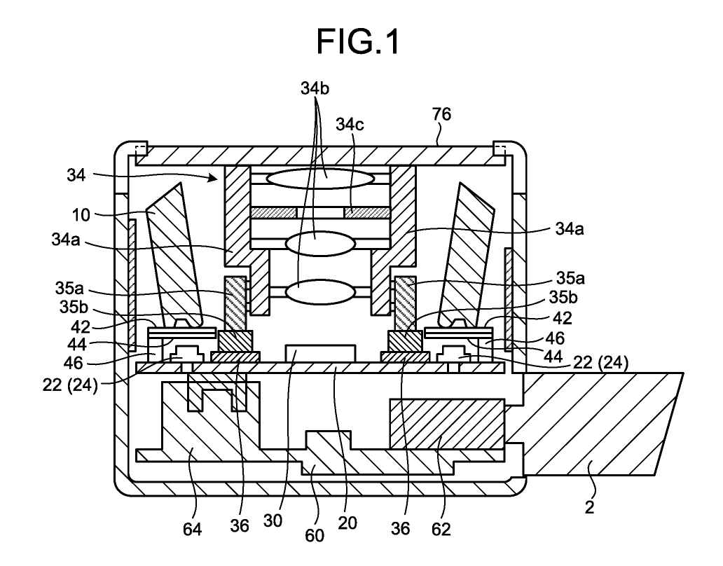

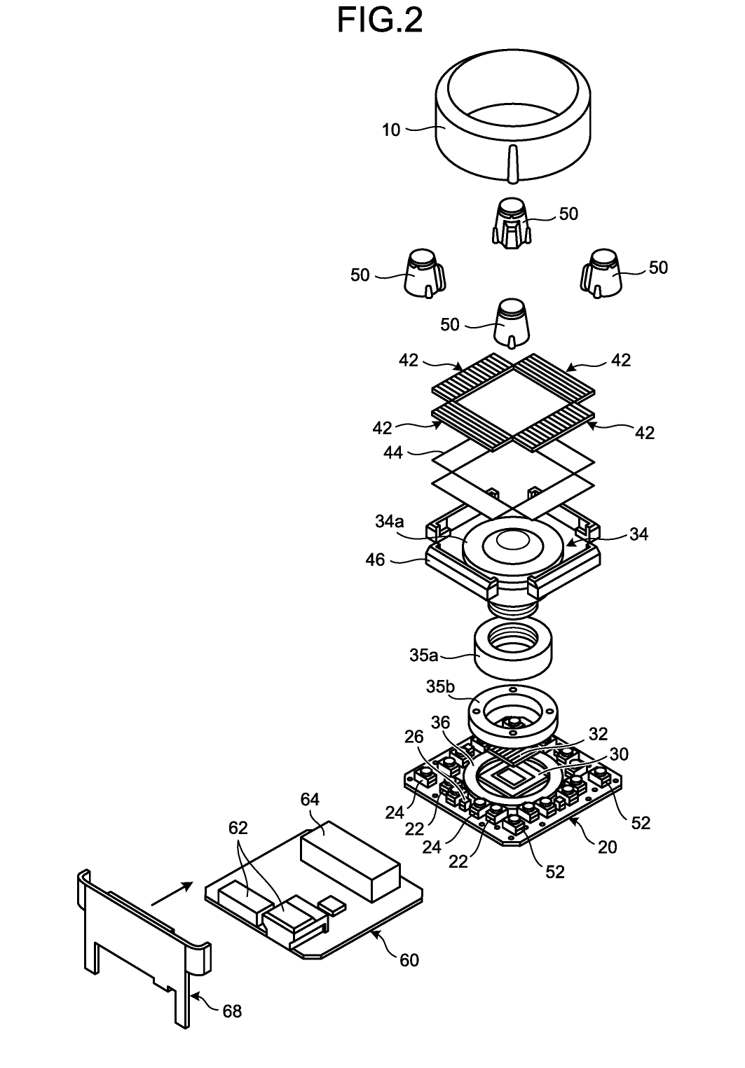

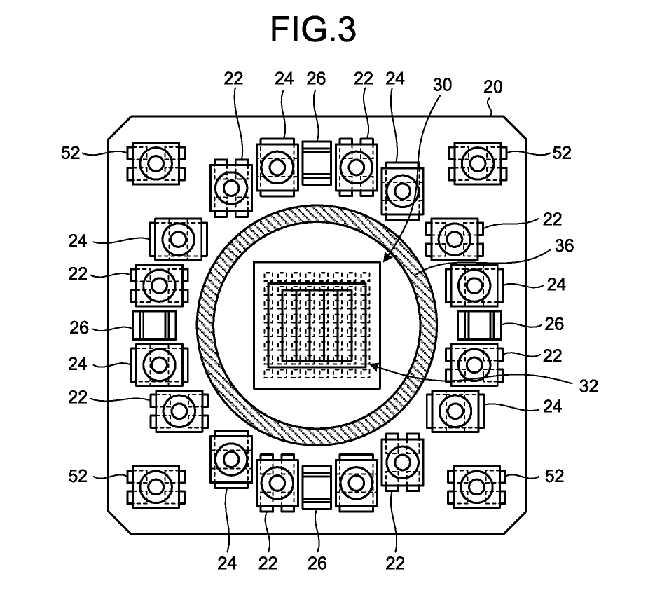

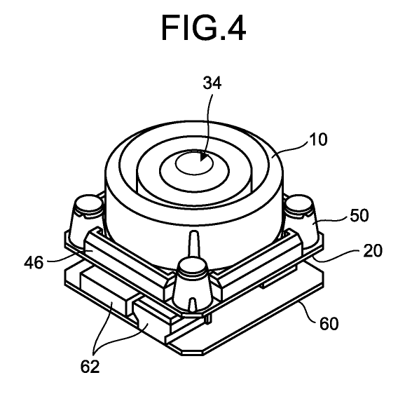

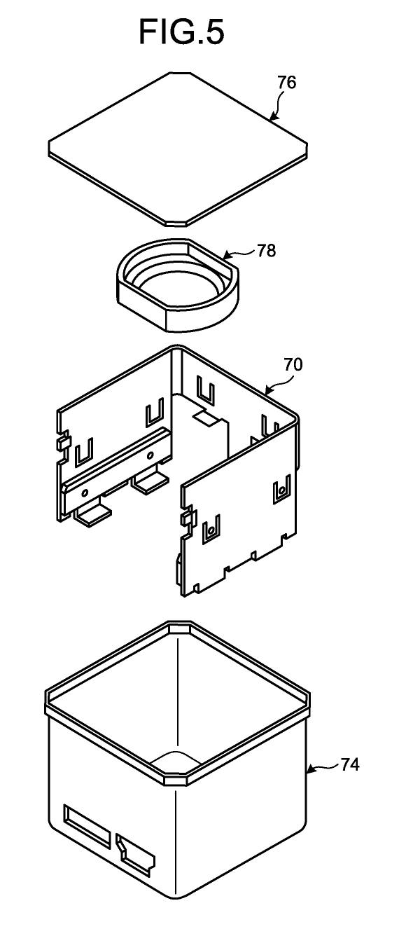

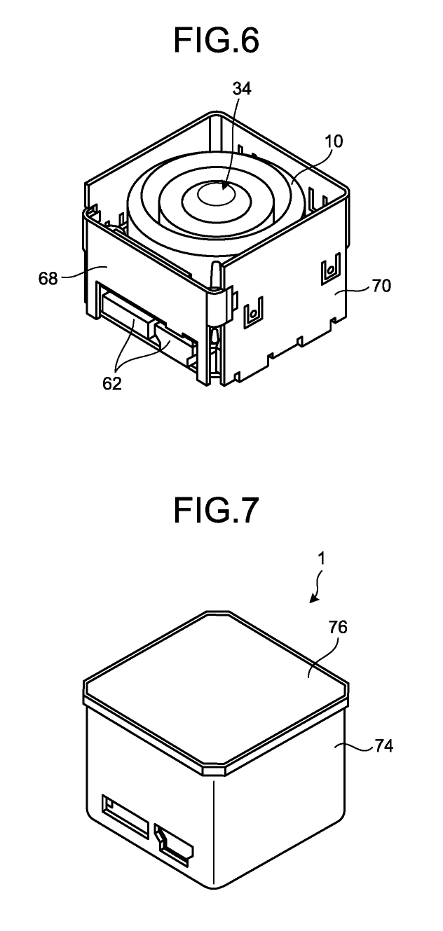

In the following, an image capturing device according to a first embodiment will be described with reference to FIGS. 1 to 7. FIG. 1 is a sectional view illustrating an image capturing device according to the first embodiment. FIG. 2 is an exploded perspective view illustrating the image capturing device according to the first embodiment. FIG. 3 is a plan view illustrating a board included in the image capturing device according to the first embodiment. FIG. 4 is a perspective view illustrating the main section of the image capturing device according to the first embodiment. FIG. 5 is an exploded perspective view illustrating an outer packaging section of the image capturing device according to the first embodiment. FIG. 6 is a perspective view illustrating the section except for a visible light cut filter plate of the image capturing device according to the first embodiment. FIG. 7 is a perspective view illustrating the image capturing device according to the first embodiment.

First, the configuration of each of the units in the image capturing device according to the first embodiment will be described. As illustrated in FIG. 2, at the center of a camera board 20, an image sensor 30, such as a CMOS image sensor, or the like, and a polarizing plate 32 are provided. A mount attachment portion 36, a plurality of light emitting devices 22 and 24, and light receiving devices 26 are provided around the image sensor 30 on the camera board 20.

A description will be given in detail with reference to FIG. 3. The image sensor 30 is mounted at the center of the camera board 20 and the polarizing plate 32 is bonded onto the image sensor 30. The camera board 20 is made of a material of, for example, a glass-filled epoxy material or the like that is hard and has a low coefficient of thermal expansion. On the camera board 20, the mount attachment portion 36 made of a smooth material of, for example, a copper foil or the like is formed along the substantially circle around the image sensor 30. Furthermore, on the camera board 20, the plurality of the light emitting devices 22 and 24 and the light receiving devices 26 are mounted along the substantially circle around the mount attachment portion 36. Hereinafter, the light emitting devices 22 are referred to as first light emitting devices 22 and the light emitting devices 24 are referred to as second light emitting devices 24.

The light receiving devices (photodiodes) 26 are provided between the first light emitting devices 22 and the second light emitting devices 24. The light receiving devices 26 are provided to receive the light from the first light emitting devices 22 and the second light emitting devices 24 (light reflected from diffusing plates 44 that will be described later) and perform automatic power control (APC: Auto Power Control) of the first light emitting devices 22 and the second light emitting devices 24.

The first light emitting devices 22 and the second light emitting devices 24 are driven to emit light at, for example, individual timings. In order to perform automatic power control of each of the first light emitting devices 22 and the second light emitting devices 24 that emit light at individual timings, the light receiving devices 26 are arranged between the first light emitting devices 22 and the second light emitting devices 24 such that the single light receiving device 26 receives the light from the first light emitting devices 22 and the second light emitting devices 24. Consequently, it is possible to reduce the number of light receiving devices used to perform, for example, APC control.

Furthermore, at the four corners of the camera board 20, four distance measurement purpose light emitting devices 52 used to measure a distance to a target object are provided. As illustrated in FIG. 3, the four distance measurement purpose light emitting devices 52 are arranged on the diagonal lines of the camera board 20 and are arranged with a furthest space therebetween on the diagonal lines. The distance to the target object (in this case, a palm) or the inclination of the target object is detected from the distance measured by the four distance measurement purpose light emitting devices 52. Furthermore, the number of the distance measurement purpose light emitting devices 52 is not limited to four. The number of the distance measurement purpose light emitting devices 52 may be, for example, at least three in order to detect an inclination. Similarly, the number of the distance measurement purpose light emitting devices 52 may also be, for example, 1 or 2 in a case where an inclination is not detected.

Namely, on the single camera board 20, the first light emitting devices 22 and the second light emitting devices 24, the light receiving devices 26, the image sensor 30, the polarizing plate 32 are provided and, furthermore, the distance measurement purpose light emitting devices 52 are provided, all of which are used to capture an image of a target object.

A description will be given here by referring back to FIG. 2. Four diffusing plates 44 and four polarizing plates 42 are provided above the first light emitting devices 22 and the light emitting devices 24 on the camera board 20. The diffusing plates 44 and the polarizing plates 42 are bonded to polarization/diffusion bases 46 attached to the four sides of the camera board 20. The diffusing plates 44 diffuse, to some extent, light emitting distribution having directivity emitted from the first light emitting devices 22 and the second light emitting devices 24. The polarizing plates 42 convert random polarized light of the first light emitting devices 22 and the second light emitting devices 24 to linearly polarized light.

A ring-shaped light guiding element 10 is provided above the four polarizing plates 42. The light guiding element 10 is formed of, for example, a resin, upwardly guides the light of the first light emitting devices 22 and the second light emitting devices 24 provided on the camera board 20, and irradiates a target object with uniform light. Consequently, the light guiding element 10 have a substantially circular shape in accordance with the arrangement of the first light emitting devices 22 and the second light emitting devices 24 on the camera board 20. The light guiding element 10 irradiates a target object with uniform light while upwardly guiding the light emitted from the first light emitting devices 22 and the second light emitting devices 24.

Furthermore, a optical unit 34 is attached, on the camera board 20, above the image sensor 30 disposed at substantially the center of the camera board 20 and inside the substantially circular light guiding element 10. The optical unit 34 includes a lens optical system including, for example, three focusing lenses 34b, an aperture portion 34c, or the like, that are attached to a barrel 34a. The optical unit 34 forms an image of an object on the image sensor 30 on the camera board 20. Furthermore, an upper-side mount 35a is attached to a lower-side mount 35b while the optical unit 34 is being screwed into the upper-side mount 35a.

For example, the barrel 34a, the upper-side mount 35a, and the lower-side mount 35b in the optical unit 34 are formed of the same material, such as an acrylonitrile butadiene styrene (ABS) resin, or the like, whose workability is high. By forming the barrel 34a, the upper-side mount 35a, and the lower-side mount 35b using the same material, it is possible to expect high adhesive strength when they are bonded and fixed.

As illustrated in FIG. 1 and FIG. 2, the barrel 34a is provided such that, in a substantially cylindrical portion, a plurality of lenses, for example, the three focusing lenses 34b are provided as a set. Furthermore, in the barrel 34a, the aperture portion 34c that adjusts emission light and incident light is provided between the focusing lenses 34b in the substantially cylindrical interior. Then, screw threads are formed at the substantially cylindrical outer periphery of the barrel 34a.

The upper-side mount 35a has a substantially cylindrical shape. On the side of one of the both end surfaces of the substantially cylindrical upper-side mount 35a, the screw threads are formed in the substantially cylindrical inner periphery. Then, the barrel 34a is screwed into the upper-side mount 35a from the side of one of the both end surfaces of the substantially cylindrical upper-side mount 35a such that the portions in which the screw threads of the barrel 34a are formed screw together the portions in which the screw threads are formed in the substantially cylindrical inner periphery.

The lower-side mount 35b has a substantially cylindrical shape. On the circumference on the side of one of the both end surfaces of the substantially cylindrical lower-side mount 35b, the upper-side mount 35a is arranged such that the circumference of the other one of the both end surfaces of the substantially cylindrical upper-side mount 35a is located at substantially concentric circles and the lower-side mount 35b is bonded to the upper-side mount 35a by using, for example, an ultraviolet curable resin, or the like. Furthermore, the lower-side mount 35b is arranged on the mount attachment portion 36 such that the circumference on the side of one of the both end surfaces of the substantially cylindrical lower-side mount 35b is located at substantially concentric circles with respect to the substantially circular mount attachment portion 36 that is formed on the camera board 20 and is attached to the camera board 20 by using, for example, a mechanical method, such as a method of fixing by a screw, or the like. The mount attachment portion 36 is formed on the camera board 20 in a substantially cylindrical shape by, for example, a copper foil, or the like.

Apertures 50 are attached on the distance measurement purpose light emitting devices 52 on the camera board 20. Each of the apertures 50 blocks light diffused to the other direction such that the light from the distance measurement purpose light emitting devices 52 is directed towards the direction of the target object.

Furthermore, in the image capturing device according to the first embodiment, in addition to the camera board 20, a control board 60 is provided. The control board 60 is used to connect to an external unit and includes an external connector 62 and a camera connector 64 that is used to connect to the camera board 20. The control board 60 is provided at the lower portion of the camera board 20 and is electrically connected to the camera board 20 by the camera connector 64. Furthermore, due to the external connector 62, a holder cover 68 is provided.

In this way, the image sensor 30, the first light emitting devices 22 and the second light emitting devices 24, the light receiving devices 26, and the distance measurement purpose light emitting devices 52 are mounted on the camera board 20. Then, the polarization/diffusion bases 46, the diffusing plates 44, the polarizing plates 42, the apertures 50, the optical unit 34, and the light guiding element 10 are attached to the camera board 20 and a camera section is assembled. The control board 60 is attached to the camera section. FIG. 4 illustrates the state of a unit after the camera section is attached to the control board 60.

Furthermore, as illustrated in FIG. 5, a visible light cut filter plate 76, a hood 78, a holder assembly 70, and an outer packaging case 74 are prepared. Then, the attachment unit illustrated in FIG. 4 is attached to the holder assembly 70 illustrated in FIG. 5 and, furthermore, the holder cover 68 illustrated in FIG. 2 is attached to the holder assembly 70, thus assembling the configuration illustrated in FIG. 6.

This configuration illustrated in FIG. 6 is accommodated in the outer packaging case 74 illustrated in FIG. 5 and, furthermore, the visible light cut filter plate 76 to which the hood 78 is attached is attached to the upper portion of the outer packaging case 74, thus assembling an image capturing device 1 illustrated in FIG. 7. The visible light cut filter plate 76 cuts the visible light component getting into the image sensor 30 from the external portion. Furthermore, as also described in FIG. 1, the hood 78 prevents the light outside a predetermined image capturing region from getting into the optical unit 34 and prevents the light that leaks from the light guiding element 10 from intruding into the optical unit 34.

FIG. 1 is a sectional view of the image capturing device 1 indicated by the state of the completed body thereof illustrated in FIG. 7. As described above, the image sensor 30, the first light emitting devices 22 and the second light emitting devices 24, the light receiving devices 26, and the distance measurement purpose light emitting devices 52 are mounted on the camera board 20.

Furthermore, the ring-shaped light guiding element 10 is provided on the upper portion of the first light emitting devices 22 and the second light emitting devices 24, introduces the light emitted from the first light emitting devices 22 and the second light emitting devices 24 upward, and emits the light toward an external image capturing target via the visible light cut filter plate 76. Consequently, it is possible to provide the first light emitting devices 22 and the second light emitting devices 24 close to the image sensor 30 and the same camera board 20, thus reducing the size and illuminating the target object with uniform light. Namely, uniform light can be illuminated in the image capturing range of the image capturing device 1.

Furthermore, because the light guiding element 10 has a ring shape, the optical unit 34 can be accommodated in the light guiding element 10, thus further reducing the size. Furthermore, the hood 78 prevents the light outside a predetermined image capturing region of the image capturing device 1 from getting into the optical unit 34 and prevents the light that leaks from the light guiding element 10 from intruding into the optical unit 34. Consequently, even if the light guiding element 10 and the first light emitting devices 22 and the second light emitting devices 24 are provided close to the image sensor 30 and the optical unit 34, it is possible to prevent a decrease in the accuracy of image capturing.

Furthermore, because the distance measurement purpose light emitting devices 52 are provided on the camera board 20, the size of a camera unit that measures a distance can be further reduced. Furthermore, in FIG. 1, the control board 60 is connected to the lower portion of the camera board 20 and, furthermore, the external cable 2 is connected to the external connector 62 on the control board 60.

(Attachment of the Image Capturing Device According to the First Embodiment)

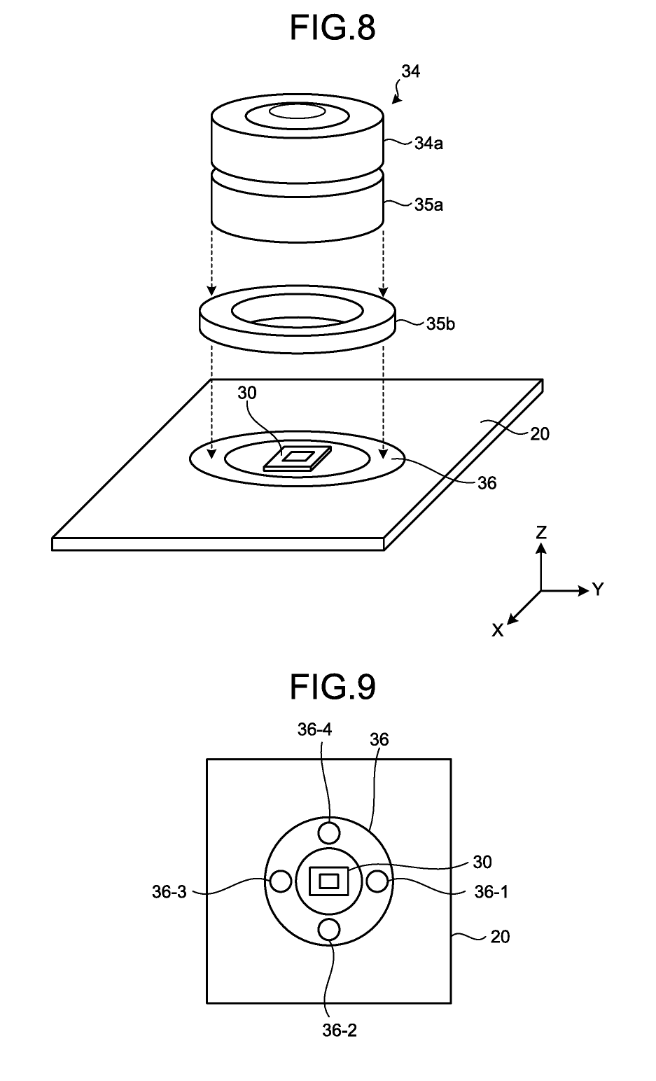

In the following, an aspect in which the optical unit of the image capturing device according to the first embodiment will be described with reference to FIGS. 8 to 15. In FIGS. 8 to 15, to simplify descriptions, the configuration of the image capturing system is mainly described from among the configurations of the image capturing system and the configurations other than the image capturing system illustrated in FIG. 1 and, regarding the configurations other than the image capturing system, illustrations and descriptions thereof will be omitted. The configuration of the image capturing system includes the image sensor 30 on the camera board 20 and the optical unit 34 that captures an image of an object onto the image sensor 30. Furthermore, the configuration of the image capturing system includes the upper-side mount 35a into which the optical unit 34 is screwed, the lower-side mount 35b that is joined to the upper-side mount 35a, and the mount attachment portion 36 in which the lower-side mount 35b is arranged.

(Attachment of the Optical Unit or the Like to the Camera Board According to the First Embodiment)

FIG. 8 is a diagram illustrating an aspect in which the optical unit or the like of the image capturing device according to the first embodiment is attached to the camera board. Here, XYZ space mentioned in a description below is the space in which the X-axis and the Y-axis are taken on the plane of the camera board 20 and the Z-axis is taken in the vertical direction of the camera board 20.

As illustrated in FIG. 8, the barrel 34a in the optical unit 34 is screwed into the upper-side mount 35a. Furthermore, the lower-side mount 35b is arranged on the mount attachment portion 36 that is formed around the image sensor 30 on the camera board 20 and is mechanically attached by using screws or the like. In the state in which the barrel 34a is screwed into the upper-side mount 35a, the upper-side mount 35a is mounted on the lower-side mount 35b that is arranged on the mount attachment portion 36.

The upper-side mount 35a and the lower-side mount 35b are formed of the same material, such as an ABS resin, or the like. The contact surface of the upper-side mount 35a and the lower-side mount 35b is a smooth surface and, when each of the positions thereof is adjusted by sliding and making contact with each other, it is possible to implement smooth sliding by reducing the coefficient of friction. Furthermore, by making close contact with the upper-side mount 35a and the lower-side mount 35b, it is possible to prevent leakage light or the like from being generated.

Then, the upper-side mount 35a and the lower-side mount 35b are fixed by an adhesive, such as an ultraviolet curable resin, or the like. Here, because the upper-side mount 35a and the lower-side mount 35b are formed of the same material, even if an adhesive is used to fix these parts, the contact surfaces are firmly fixed with each other.

(Mount Attachment Portion According to the First Embodiment)

FIG. 9 is a diagram illustrating the mount attachment portion in which the lower-side mount of the image capturing device according to the first embodiment is attached to the camera board. The mount attachment portion 36 is a land formed in a substantially circular shape around the image sensor 30 on the camera board 20 by using a material, such as a flat and smooth copper foil, or the like, that has the coefficient of friction smaller than a predetermined value. The mount attachment portion 36 has an outer diameter equal to or greater than the outer diameter of the lower-side mount 35b and has an inner diameter equal to or less than the inner diameter of the lower-side mount 35b. In contrast, because the upper-side mount 35a needs to slide on the lower-side mount 35b at the time of adjustment of the optical axis, the upper-side mount 35a has the outer diameter equal to or less than the outer diameter of the lower-side mount 35b. For example, regarding the outer diameter of the upper-side mount 35a and the lower-side mount 35b, if the outer diameter of the lower-side mount 35b is greater by about 300 to 500 μm, the upper-side mount 35a is allowed to move on the lower-side mount 35b and adjustment of the optical axis can be performed.

In this way, by forming the mount attachment portion 36 to which the lower-side mount 35b is attached by using a copper foil or the like, a smooth surface is obtained by eliminating unevenness of the contact portion with the lower-side mount 35b. Consequently, when the lower-side mount 35b is attached to the mount attachment portion 36 and is fixed, it is possible to prevent a gap from being generated between the mount attachment portion 36 and the lower-side mount 35b and avoid intrusion of the leakage light from getting into inside the mounting section. In other words, it is possible to prevent the image sensor 30 from being exposed by leakage light.

Furthermore, the mount attachment portion 36 includes four screw holes 36-1 to 36-4 that are arranged at substantially regular intervals on a substantially annular plane and that reach the camera board 20.

(State in which the Lower-Side Mount and the Lower-Side Mount According to the First Embodiment are Attached to the Mount Attachment Portion)

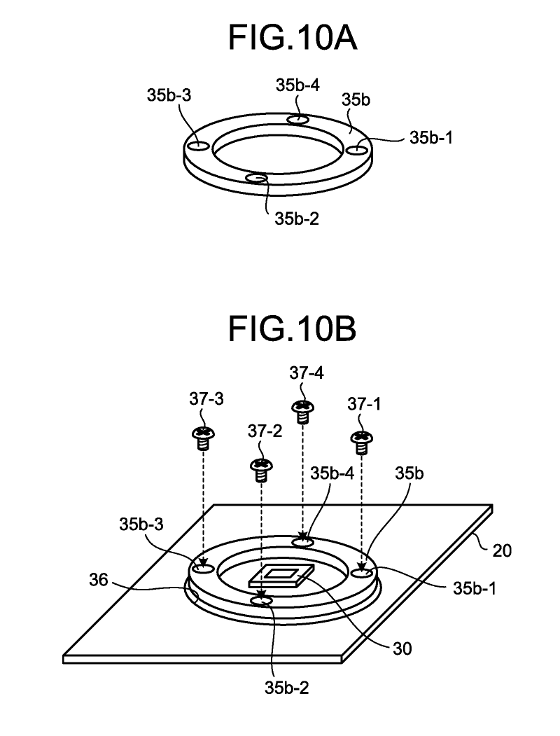

FIG. 10A is a perspective view illustrating the lower-side mount of the image capturing device according to the first embodiment. FIG. 10B is a perspective view illustrating the state in which the lower-side mount of the image capturing device according to the first embodiment is attached to the mount attachment portion on the camera board. As illustrated in FIG. 10A, the lower-side mount 35b includes four screw through-holes 35b-1 to 35b-4 formed to be countersunk at substantially regular intervals on an annular plane such that, for example, the head of the screws passing through the hole gets into the screw through-holes 35b-1 to 35b-4. As illustrated in FIG. 10B, the lower-side mount 35b is arranged on the mount attachment portion 36 on the camera board 20 such that the four sets of the screw through-holes and the screw holes, i.e., the four sets of the screw through-hole 35b-1 and the screw hole 36-1 to the screw through-hole 35b-4 and the screw hole 36-4 match.

Then, the screw 37-1 is screwed into the screw hole 36-1 in the camera board 20 via the screw through-hole 35b-1. Similarly, the screw 37-2 is screwed into the screw hole 36-2 in the camera board 20 via the screw through-hole 35b-2. Similarly, the screw 37-3 is screwed into the screw hole 36-3 in the camera board 20 via the screw through-hole 35b-3. Similarly, the screw 37-4 is screwed into the screw hole 36-4 in the camera board 20 via the screw through-hole 35b-4. In this way, the lower-side mount 35b is fixed to the camera board 20 at the position of the mount attachment portion 36 on the camera board 20 by screw joining.

(Attachment State of the Optical Unit or the Like According to the First Embodiment on the Camera Board)

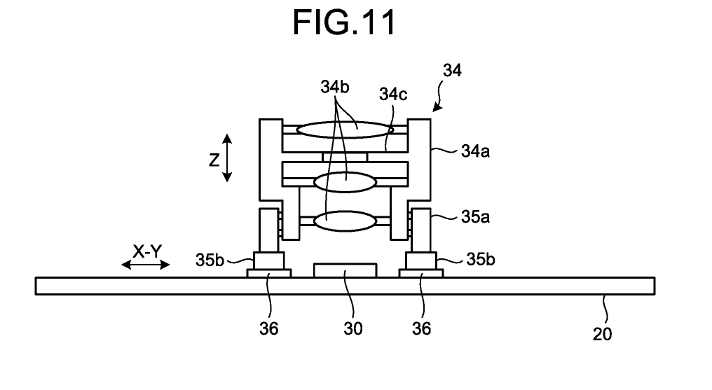

FIG. 11 is a sectional view illustrating the state in which the optical unit or the like of the image capturing device according to the first embodiment is attached to the camera board. When the upper-side mount 35a is attached to the lower-side mount 35b that is attached to the camera board 20 as illustrated in FIG. 10B, the state illustrated in FIG. 11 is obtained. As illustrated in FIG. 11, the mount attachment portion 36, the lower-side mount 35b, the upper-side mount 35a, and the barrel 34a are located on the camera board 20 in this order in the Z-axis direction, i.e., from the lower to the upper direction of the camera board 20, and covers the image sensor 30 on the camera board 20.

(Positional Adjustment of the Upper-Side Mount According to the First Embodiment in the Direction of the X-Axis and the Y-Axis)

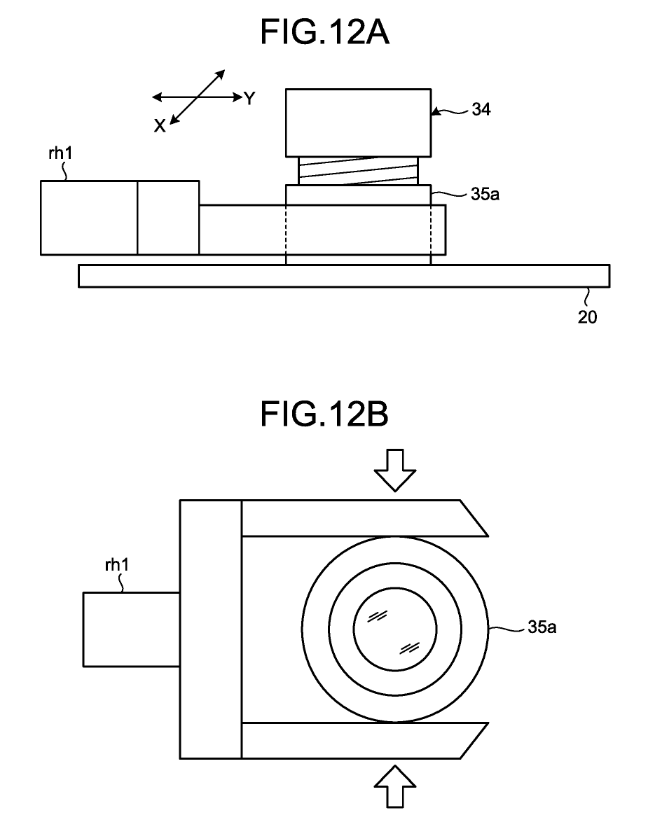

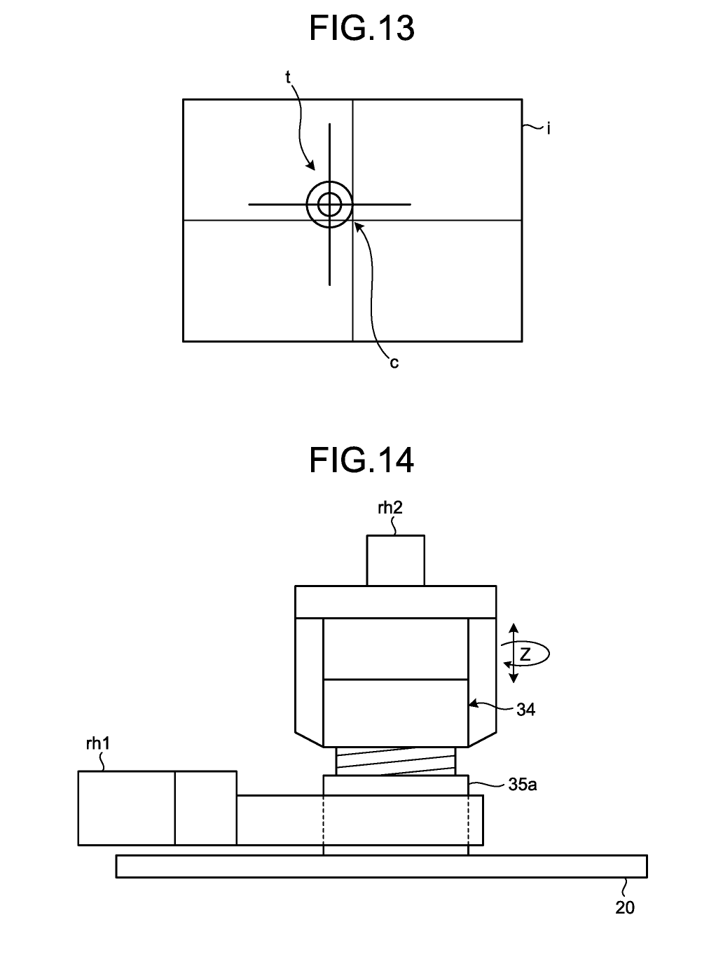

FIG. 12A is a side view illustrating the aspect in which positional adjustment of the optical unit and the upper-side mount of the image capturing device according to the first embodiment is performed on the camera board in the direction of the X-axis and the Y-axis. FIG. 12B is a plan view illustrating the aspect in which positional adjustment of the optical unit and the upper-side mount of the image capturing device according to the first embodiment is performed on the camera board in the direction of the X-axis and the Y-axis. Furthermore, FIG. 13 is a diagram illustrating a target mark that is used when positional adjustment of the optical unit and the upper-side mount of the image capturing device according to the first embodiment is performed on the camera board in the direction of the X-axis and the Y-axis. As illustrated in FIGS. 12A and 12B, in order to match a target mark t and the center c of an imaging plane i of the image sensor 30 illustrated in FIG. 13, a manufacturing apparatus (not illustrated) holds, by using a robot hand rh1, the upper-side mount 35a into which the barrel 34a is screwed, and performs optical axis adjustment in which the barrel 34a and the upper-side mount 35a are moved and adjusted on the camera board 20 in the direction of the X-axis and the Y-axis. In FIG. 13, the center c corresponds to the center of the imaging plane i of the image sensor 30, and the target mark t corresponds to the captured image of the actual target mark printed on an adjustment chart. Here, the actual target mark on the adjustment chart is arranged at the position matched on the vertical line of the center of the image sensor 30 when the camera board 20 is set in an adjustment device.

(Focus Adjustment of the Upper-Side Mount) According to the First Embodiment in the Z-Axis Direction

FIG. 14 is a diagram illustrating the aspect in which the focus adjustment of the upper-side mount of the optical unit of the image capturing device according to the first embodiment is performed in the Z-axis direction. After having performed the optical axis adjustment of the optical unit 34 and the upper-side mount 35a as illustrated in FIGS. 12A and 12B, the manufacturing apparatus (not illustrated) holds, as illustrated in FIG. 14, the optical unit 34 by the robot hand rh2 while holding the upper-side mount 35a by the robot hand rh1. Then, the manufacturing apparatus performs the focus adjustment that adjusts the position of the optical unit 34 screwed into the upper-side mount 35a in the Z-axis direction by moving the optical unit 34 up and down in the Z-axis direction until the optical unit 34 reaches the lens focal position of the optical unit 34. The focus adjustment of the optical unit 34 in the Z-axis is performed by searching for an optimum focal position of the lens of the optical unit 34 by performing image processing on the imaging plane i (see FIG. 13).

Furthermore, there may be a case in which, due to an inclination of the optical axis of the lens of the optical unit 34, a shift of the barrel 34a from the Z-axis direction that is the moving direction, the target mark t (see FIG. 13) and the center c (see FIG. 13) of the imaging plane i are shifted after the adjustment of the position in which the optical unit 34 is screwed into the Z-axis direction. In this case, the manufacturing apparatus again performs the optical axis adjustment after the focus adjustment and matches the target mark t and the center c of the imaging plane i. In this way, the manufacturing apparatus may also repeat the optical axis adjustment and the focus adjustment until the position of the optical axis and the focal position are optimum.

(Adhesion of the Upper-Side Mount of the Optical Unit According to the First Embodiment to the Lower-Side Mount)

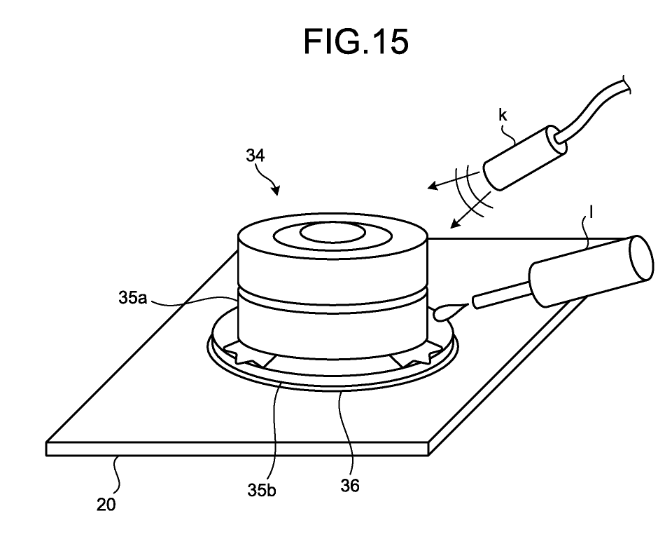

FIG. 15 is a diagram illustrating the aspect in which the upper-side mount of the optical unit of the image capturing device according to the first embodiment is bonded to the lower-side mount. After both positional adjustment and focus adjustment are completed, as illustrated in FIG. 15, the manufacturing apparatus (not illustrated) bonds the upper-side mount 35a to the lower-side mount 35b by an ultraviolet curable resin or the like ejected from an injector 1. Then, the manufacturing apparatus irradiates the adhesive section of the upper-side mount 35a and the lower-side mount 35b with ultraviolet light by an irradiator k, cures the ultraviolet curable resin, and fixes the adhesive section of the upper-side mount 35a and the lower-side mount 35b.

Because the upper-side mount 35a and the lower-side mount 35b are formed of a resin with the same material, even if the adhesive surface is smooth, the upper-side mount 35a and the lower-side mount 35b can be fixed by using an adhesive and the adhesive strength can be sufficiently high. Furthermore, a suitable adhesive can be selected from a wide range of options to bond the upper-side mount 35a to the lower-side mount 35b of the same material.

(Attachment Process Performed by the Manufacturing Apparatus)

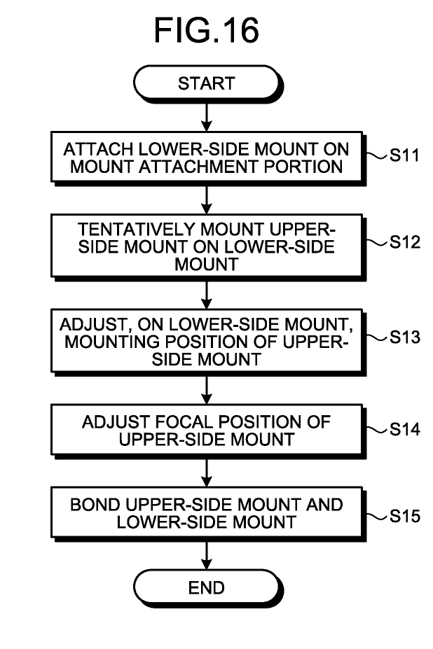

FIG. 16 is a flowchart illustrating an attachment process of attaching the optical unit of the image capturing device according to the first embodiment to the camera board. First, the lower-side mount 35b is attached on the mount attachment portion 36 that is previously formed on the camera board 20 by using screws (Step S11).

Then, the manufacturing apparatus (not illustrated) tentatively mounts, on the lower-side mount 35b attached on the camera board 20 at Step S11, the upper-side mount 35a into which the optical unit 34 is screwed (Step S12). Then, the manufacturing apparatus adjusts, on the lower-side mount 35b, the mounting position of the upper-side mount 35a that is tentatively mounted at Step S12 by moving the mounting position in the direction of the X-axis and the Y-axis of the camera board 20 (Step S13).

Then, the manufacturing apparatus adjusts the focal position of the optical unit 34 by rotating the optical unit 34 that is screwed into the upper-side mount 35a whose position on the camera board 20 in the direction of the X-axis and the Y-axis has been adjusted at Step S13 (Step S14). Then, the manufacturing apparatus bonds the upper-side mount 35a and the lower-side mount 35b by an ultraviolet curable resin (Step S15).

### Modification of the First Embodiment

### (1) Joining of the Lower-Side Mount 35b and the Camera Board 20

In the first embodiment, the joining of the lower-side mount 35b and the camera board 20 is performed by screw joining. However, the joining of the lower-side mount 35b and the camera board 20 is not limited to screw joining and various mechanical joining methods may also be used for the joining. For example, the joining of the lower-side mount 35b and the camera board 20 may also be performed by providing a through-hole for a bolt in the camera board 20 and by fastening the bolt and a nut so as to sandwich the lower-side mount 35b and the camera board 20 by the bolt and the nut. Alternatively, the joining of the lower-side mount 35b and the camera board 20 may also be performed by providing a through-hole for a bolt in the camera board 20, sandwiching the lower-side mount 35b and the camera board 20 by the bolt and a back plate of a back surface of the camera board 20, and fastening the bolt and the back plate. Alternatively, the lower-side mount 35b and the camera board 20 may also be joined by caulking (rivet joining). In any of these cases, because the lower-side mount 35b and the camera board 20 are joined by mechanical joining, firm joining can be implemented.

### (2) Joining of the Upper-Side Mount 35a and the Lower-Side Mount 35b

In the first embodiment, the joining of the upper-side mount 35a and the lower-side mount 35b is performed by an adhesive using an ultraviolet curable resin. However, the joining of the upper-side mount 35a and the lower-side mount 35b is not limited to this and the joining may also be performed by a hot-melt method that uses an adhesive material appropriate for the material of the upper-side mount 35a and the lower-side mount 35b. Alternatively, the joining of the upper-side mount 35a and the lower-side mount 35b may also be performed by thermal welding, vibration welding, or the like in accordance with the material of the upper-side mount 35a and the lower-side mount 35b. In any of these cases, because the upper-side mount 35a and the lower-side mount 35b are formed of the same material, firm joining can be implemented.

According to the first embodiment, the mount that is used to mount the optical unit 34 on the camera board 20 includes the upper-side mount 35a and the lower-side mount 35b that are formed of using the same material and, furthermore, the lower-side mount 35b and the camera board 20 formed of different materials are joined by mechanical joining. Then, the upper-side mount 35a is bonded to the lower-side mount 35b while the optical unit 34 is screwed into the upper-side mount 35a. Consequently, in the image capturing device according to the first embodiment, because the joining of the lower-side mount 35b and the camera board 20 and the joining of the upper-side mount 35a and the lower-side mount 35b become firm, the resistance against a falling impact, a vibration, or the like can be enhanced.

### Second Embodiment

In a second embodiment, instead of the lower-side mount 35b according to the first embodiment, a lower-side mount 35c is used and metal inserts are provided at predetermined positions of the lower-side mount 35c. When the lower-side mount 35c is fixed to the mount attachment portion 36 on the camera board 20, the metal inserts and the mount attachment portion 36 are joined by soldering. The second embodiment is the same as the first embodiment regarding the other points.

(State in which the Lower-Side Mount According to the Second Embodiment are Attached to the Mount Attachment Portion)

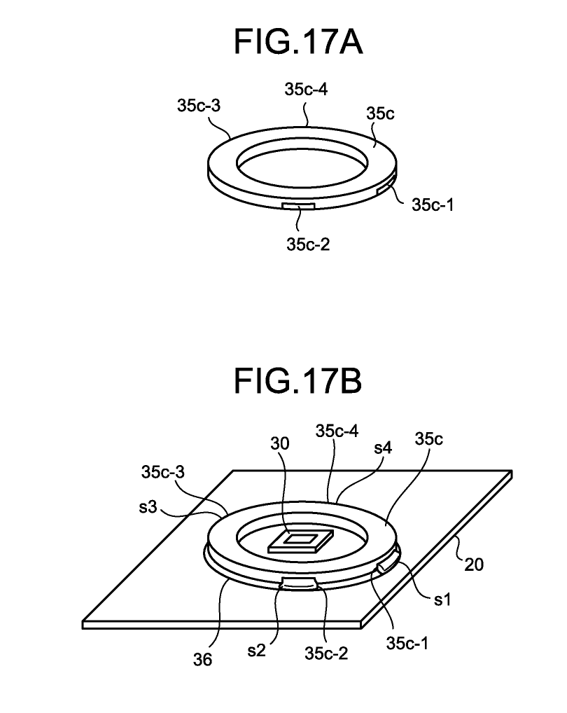

FIG. 17A is a perspective view illustrating the lower-side mount of the image capturing device according to a second embodiment. FIG. 17B is a perspective view illustrating the state in which the lower-side mount of the image capturing device according to the second embodiment is attached to a mount attachment portion on a camera board.

As illustrated in FIG. 17A, the lower-side mount 35c is integrally formed by insert molding of metal inserts 35c-1 to 35c-4 on the side surface portion of the annular ring at substantially regular intervals. Here, the material of the metal inserts 35c-1 to 35c-4 is the material appropriate for joining to the mount attachment portion 36 by solder joining. Then, as illustrated in FIG. 17B, the lower-side mount 35c is arranged on the mount attachment portion 36 on the camera board 20 and each of the metal inserts 35c-1 to 35c-4 is joined to the mount attachment portion 36 by the solder joining via solder joining portions s1 to s4.

According to the second embodiment, the metal inserts 35c-1 to 35c-4 are provided in the lower-side mount 35c and, then, the metal inserts 35c-1 to 35c-4 are joined to the mount attachment portion 36 on the camera board 20 via the solder joining portions s1 to s4. Namely, between the lower-side mount 35c and the camera board 20 formed of different materials, the metal inserts 35c-1 to 35c-4 suitable for the solder joining to the mount attachment portion 36 on the camera board 20 is provided at a predetermined portion of the lower-side mount 35c. Then, the metal inserts 35c-1 to 35c-4 are joined to the mount attachment portion 36 by the solder joining. Consequently, according to the second embodiment, the joining of the lower-side mount 35c and the camera board 20 become firm and the resistance against a falling impact, a vibration, or the like of the image capturing device can be enhanced.

### Third Embodiment

In a third embodiment, instead of the lower-side mount 35b according to the first embodiment or the lower-side mount 35c according to the second embodiment, a lower-side mount 35d having a supporting portion that supports the light guiding element 10 is used. The third embodiment is the same as the first embodiment or the second embodiment regarding the other points.

(Image Capturing Device According to the Third Embodiment)

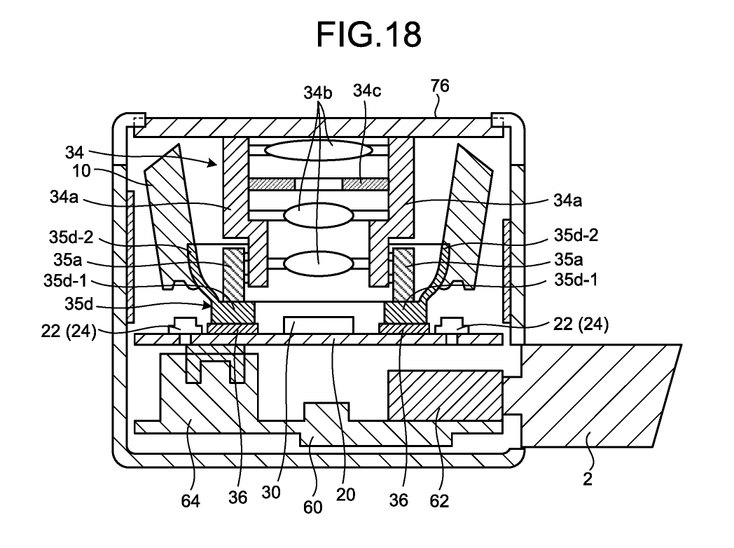

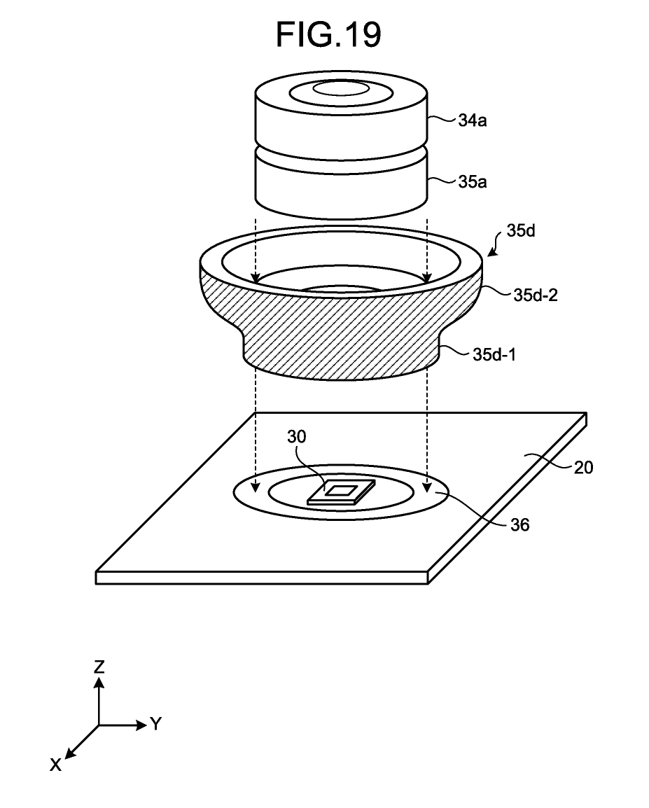

FIG. 18 is a sectional view illustrating an image capturing device according to a third embodiment. FIG. 19 is a diagram illustrating the aspect in which an optical unit of the image capturing device according to the third embodiment is attached to the camera board. As illustrated in FIGS. 18 and 19, the lower-side mount 35d includes a substantially cylindrical base plate portion 35d-1 and a supporting portion 35d-2 extending from the base plate portion 35d-1 to outside the substantially cylindrical portion so as to surround the base plate portion 35d-1. The upper-side mount 35a is bonded to the lower-side mount 35d at the base plate portion 35d-1 inside the supporting portion 35d-2. Furthermore, the lower-side mount 35d is attached to the camera board 20 by a mechanical method by being arranged to the mount attachment portion 36 such that circumference on the side of one of the substantially cylindrical base plate portion 35d-1 is located on the substantially concentric circles of the substantially circular mount attachment portion 36 formed on the camera board 20. The method of joining the mount attachment portion 36 to the lower-side mount 35d and the method of joining the lower-side mount 35d to the upper-side mount 35a are the same as that described in the first embodiment or the second embodiment.

Then, as illustrated in FIG. 18, the light guiding element 10 is attached around the supporting portion 35d-2 of the lower-side mount 35d. Furthermore, various methods, such as latching using a latching mechanism, adhesion using an adhesive, or the like, may also be used for the method of attaching the light guiding element 10 to the supporting portion 35d-2.

The present invention is not limited to the above described embodiments as they are, and may be embodied by modification of their components without departing from the substance thereof upon their implementation. Further, by appropriate combination of any components disclosed by the above described embodiments, various inventions may be formed. For example, all of the components disclosed by the embodiments may be combined as appropriate. Furthermore, the components of different ones of the embodiments may be combined as appropriate. Various modifications and applications may of course be made without departing from the gist of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image capturing device comprising:
an imaging device;
a board on which the imaging device is mounted;
an optical unit that forms an image of a target object on the imaging device; and
a mounting unit that is used to mount the optical unit on the board, wherein
the mounting unit includes a first mounting unit and a second mounting unit,
the board includes an attachment portion having a smooth surface,
the first mounting unit is attached to the attachment portion by mechanical joining, and
the second mounting unit to which the optical unit is attached is bonded to the first mounting unit.

2. The image capturing device according to claim 1, wherein the attachment portion is a land formed of copper.

3. The image capturing device according to claim 1, wherein the first mounting unit and the second mounting unit are formed of the same material.

4. The image capturing device according to claim 1, wherein, between the area of a surface of the first mounting unit and the area of a surface of the second mounting unit including an adhesive surface to which the first mounting unit and the second mounting unit are bonded each other, the area of the surface of the first mounting unit is greater than that of the second mounting unit.

5. The image capturing device according to claim 1, wherein the mechanical joining is one of screw joining, rivet joining, and solder joining that is performed between metal inserts provided at predetermined positions of the first mounting unit and the attachment portion.

6. The image capturing device according to claim 1, further comprising:
a light guiding plate that guides light emitted from a light source provided on the board, wherein
the first mounting unit further includes a supporting portion that supports the light guiding plate.

7. A method for manufacturing an image capturing device comprising:
forming, on a board, an attachment portion having a smooth surface;
attaching, between a first mounting unit and a second mounting unit that are used to mount, on the board, an optical unit that forms an image of a target object on an imaging device provided on the board, the first mounting unit to the attachment portion by mechanical joining;
mounting, on the first mounting unit, the second mounting unit while the optical unit is being attached to the second mounting unit and adjusting, on the first mounting unit, a mounting position of the second mounting unit;
adjusting a height position with respect to the optical unit while the optical unit is being attached to the second mounting unit that is mounted on the first mounting unit; and
bonding the first mounting unit and the second mounting unit after having adjusted the mounting position and the height position.
